(19) United States
(12) Patent Application Publication
(10) Pub. No.: US 2003/0212647 A1
(43) Pub. Date: Nov. 13, 2003

(54) Method, system and program product for maintaining a change history for a database design

(76) Inventors: Matthew Jay Bangel, Owego, NY (US); James A. Martin JR., Endicott, NY (US); Douglas G. Murray, Johnson City, NY (US)

Correspondence Address: HOFFMAN WARNICK & D'ALESSANDRO, LLC, 3 E-COMM SQUARE, ALBANY, NY, 12207

(21) Appl. No.: 10/140,466

(22) Filed: May 7, 2002

(51) Int. Cl. G06F 7/00

(52) U.S. Cl. 707/1

(57) ABSTRACT

A method, system and program product for maintaining a change history for a database design is provided. Specifically, a change to design of a production database is formulated using a development database. Change history data corresponding to the change is entered into a change history database. When the design change is implemented on the production database, the change history data is automatically sent thereto.

### BACKGROUND OF THE INVENTION

1. Field of the Invention

The present invention generally relates to a method, system and program product for maintaining a change history for a database design. More particularly, the present invention allows change history data corresponding to a database design change to be automatically transmitted to the changed database.

2. Background Art

In business, data management has become an important part of success. Specifically, businesses are increasingly seeking to maximize their efficiency by maintaining data regarding both their business processes, as well as their customers. Typically, such data is stored in one or more databases according to a predetermined format or design. In many instances, databases are designed for businesses by third parties that specialize in database design. This allows the businesses to remain focused on their core activities while relying on experts for proper data management.

In general, a database design is developed using a development database. This allows the database to be tested before being implemented. Once fully developed and tested, a production copy of the development database will be put into production for the user.

On occasion, the design of a production database must change. This typically occurs as new technology emerges, the needs of a business change, etc. In any event, the design of a production database is changed using the development database with which is was formed. Specifically, since the production database is a production copy of the development database, any proposed changes can be first formulated and tested on the development database. Once tested, the change can be implemented on the production database. As the change is being formulated, change history data corresponding to the change can be entered into both a change history database and the production database. The change history database allows a database developer to view all changes that have been made to the production database. Similarly, the change history within the production database allows the production database user (e.g., the business) to view the changes as well.

To date, entering of change history data into the change history database and the production database has required two separate data entry operations. That is, when a design change is implemented, an administrator is required to manually input details of the change into the change history database, and then re-input the same details into the production database. This requirement is not only tedious and inefficient, but is also ripe for data entry errors.

Therefore, there exists a need for a method, system and program product for managing a change history for a database design. Specifically, a need exists for change history data regarding a design change to a production database to be automatically transmitted to the production database. This will eliminate the problems associated with making multiple manual data entry operations for the same change history data.

### SUMMARY OF THE INVENTION

The present invention generally relates to a method, system and program product for managing a change history for a database design. Specifically, a development database having a design, and a production copy of the development database are provided. Using the development database, the design is changed. Change history data regarding the change is then entered into a change history database. Once the change is implemented on the production database, the change history data is automatically transmitted to the production database.

According to a first aspect of the present invention, a method for maintaining a change history for a database design is provided. The method comprises: (1) providing a production database having a design; (2) formulating a change to the design; (3) entering change history data corresponding to the change into a change history database; (4) implementing the change; and (5) automatically sending the change history data to the production database.

According to a second aspect of the present invention, a method for maintaining a change history for a database design is provided. The method comprises: (1) providing a development database having a design, and a production database, wherein the production database is a production copy of the development database; (2) making a change to the design on the development database; (3) entering change history data corresponding to the change into a document on a change history database; (4) implementing the change on the production database; and (5) automatically sending the change history data to the production database.

According to a third aspect of the present invention, a system for maintaining a change history for a database design is provided. The system comprises: (1) a system for formulating a change to a design of a production database on a development database; (2) a system for entering change history data corresponding to the change into a change history database; (3) a system for implementing the change on the production database; and (4) a system for automatically sending the change history data to the production database.

According to a fourth aspect of the present invention, a program product stored on a recordable medium for maintaining a change history for a database design is provided. When executed, the program product comprises: (1) program code for formulating a change to a design of a production database on a development database; (2) program code for entering change history data corresponding to the change into a change history database; (3) program code for implementing the change on the production database; and (4) program code for automatically sending the change history data to the production database.

Therefore, the present invention provides a method, system and program product for managing a change history for a database design.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a first exemplary architecture according to the present invention.

FIG. 2 depicts a second exemplary architecture according to the present invention.

FIG. 3 depicts a third exemplary architecture according to the present invention.

FIG. 4 depicts a computer system implementation of the architecture of FIG. 1.

FIG. 5 depicts a method flow diagram according to the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

The present invention provides a method, system and program product for managing a change history for a database design. Specifically, under the present invention, a development database having a design, and a production copy thereof are provided. Using the development database, the design is changed. Then, change history data corresponding to the change is entered into a change history database. After the change has been implemented on the production database, the change history data is automatically sent to the production database. Therefore, both the change history database and the production database have a record of all changes to the design without the change history data having to be entered more than once.

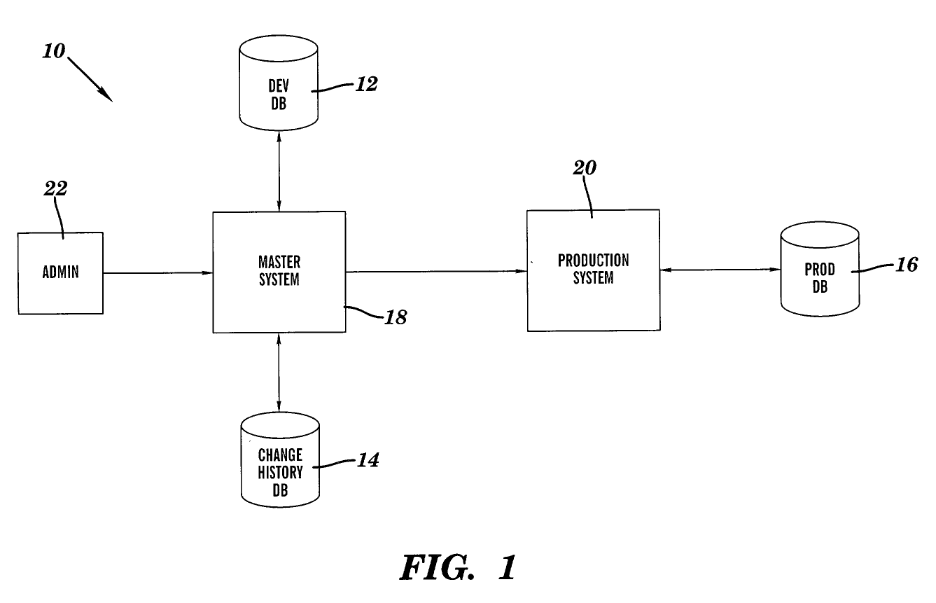

Referring now to FIG. 1, an exemplary architecture 10 of the present invention is shown. As depicted, architecture 10 includes development database 12, change history database 14, production database 16, master system 18 and production system 20. As will be further described below, databases 12, 14 and 16 provide storage for information necessary to carry out the present invention and may include one or more storage devices, such as a magnetic disk drive or an optical disk drive. In another embodiment, databases 12, 14 and 16 include data distributed across, for example, a local area network (LAN), wide area network (WAN) or a storage area network (SAN) (not shown). Databases 12, 14 and 16 may also be configured in such a way that one of ordinary skill in the art may interpret them to each include one or more storage devices.

In general, production database 16 is developed using development database 12, and is accessed via production system 20. Specifically, administrator 22, will create development database 12 with a specific design. Once the design is completed, a production copy is made (i.e., production database 16), which is accessed via production system 20. Accordingly, from a design standpoint, production database 16 is a duplicate of development database 12. That is, although the data therein may differ (e.g., development database 12 may contain test cases as opposed to actual data), the design of development database 12 and production database 16 are identical. This technique is commonly employed by third party “developers” who develop databases for customers. For example, the developer could use a first development database 12 to develop a production database 16 for customer “A,” and a second development database (not shown) to develop a second production database (not shown) for customer “B.” Thus, although not shown, the present invention can be implemented to accommodate any quantity of development databases and production databases.

As indicated above, the design of production database 16 occasionally changes. To accomplish the change under the present invention, administrator 22 will utilize master system 18 to gain access to and manipulate the design of development database 12 (i.e., formulate the change). Once the change is formulated, change history data corresponding to the change will be entered by administrator into a change history document within change history database 14 (e.g., via master system 18). Change history data comprises details regarding the design change (e.g., what change was made, when the change was made, what database was changed, etc.). This allows administrator 22 to be able to access change history database 14 to view a complete depiction of all changes made to databases 12 and 16. Then, as the change is implemented on production database 16, the corresponding change history data is automatically transmitted thereto. Specifically, the change to the design made on development database 12 will be implemented (e.g., refreshed) to the corresponding production database 16 (via production system 20). Simultaneously, or thereafter, the entered change history data will be transmitted to a profile document in production database 16, and the version number of production database 16 will be optionally updated. As will be further described below, the profile document lists the entire change history of production database 16. Thus, a user of production system 20 and production database 16 can view the profile document at any time to observe all changes that have been made to production database 16 since its inception. As used herein, the term document (e.g., change history document, profile document, etc.) is intended to mean any convention record or form that captures information.

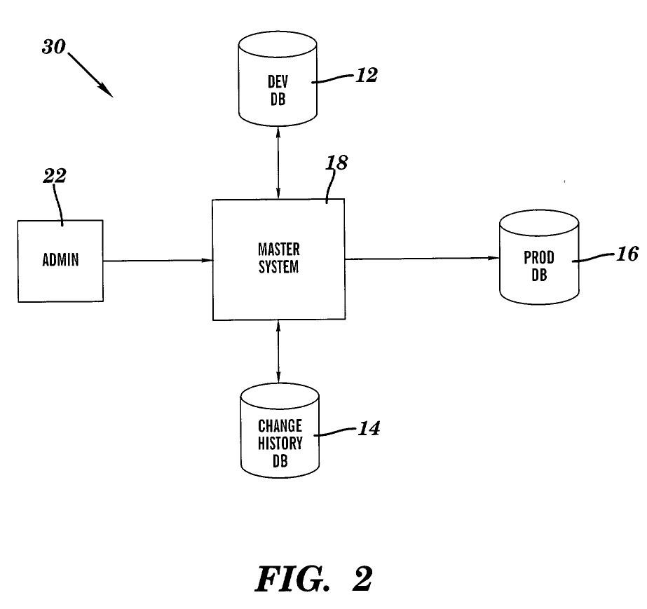

It should be understood that the architecture shown in FIG. 1 is exemplary only, and that many variations could be implemented under the present invention as long as the entered change history data is automatically transmitted to the production database. FIG. 2 depicts another exemplary architecture 30 that could be implemented. As shown, architecture 30 differs from architecture 10 in that production system 20 is not present. Accordingly all database 12, 14 and 16 can be accessed/manipulated via master system 18. This difference does not effect the manner in which the design of production database 16 is created and/or changed. Specifically, administrator 22 will use development database 12 to create a design. Production database 16 is then created by copying the created design. When a design change is desired, administrator 22 will formulate the change on development database 12, and enter change history data into a change history document within change history database 14. When the change is implemented on production database 16, the entered change history data will be automatically transmitted to production database 16 (e.g., to the profile document), and the version number thereof will be optionally updated.

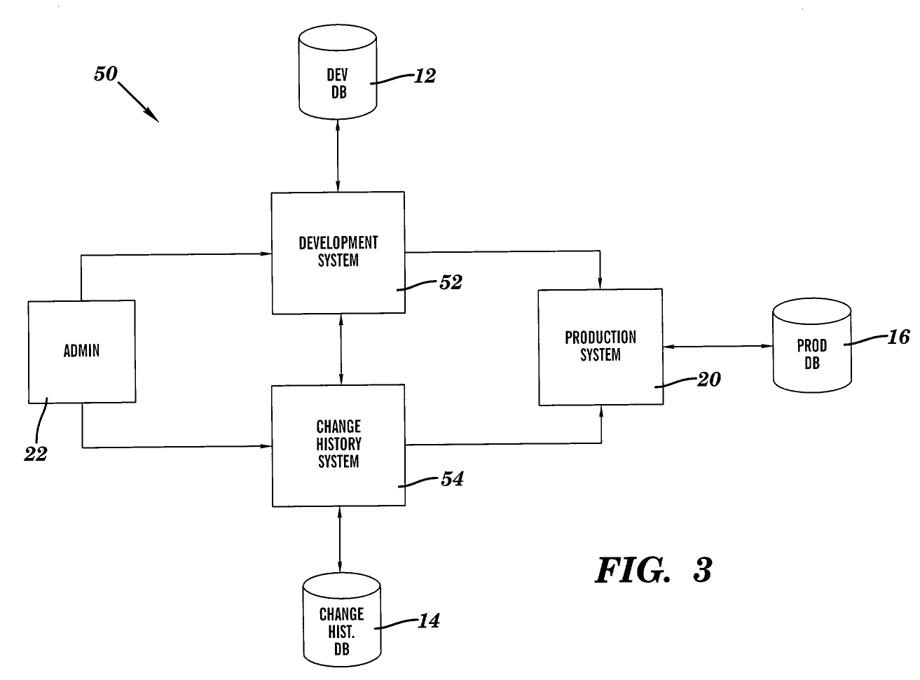

FIG. 3 depicts yet another exemplary architecture 50 that could be implemented under the present invention. As depicted, architecture 50 includes a separate system for accessing/manipulating each separate database. Specifically, architecture 50 includes development system 52 for accessing/manipulating development database 12, change history system 54 for accessing/manipulating change history database 14 and production system 20 for accessing/manipulating production database 16. Accordingly, administrator 22 will use development system 52 to create a design for development database 12, and to make a production copy to yield production database 16. When a change to the design is desired, administrator 22 will use development system 52 to formulate the change to the design, and change history system 54 to enter corresponding change history data into a change history document within change history database 14. Similar to FIG. 1, when the change is implemented on production database 16, the change history data is automatically transmitted from change history database 14 to production database 16 and the version number of production database 16 is optionally updated.

In implementing the design change and transmitting the change history data, administrator 22 could send separate commands to development system 52 and change history system 54, respectively. Alternatively, upon issuing a command via development system 52 to implement the change, an instruction could be automatically generated by development system 52 and sent to change history system 54. The instruction would cause change history system 54 to automatically transmit the change history data corresponding to the change to the profile document in production database 16. In either event, the change history data is transmitted to the production database 16 without the need for manual reentry.

It should be understood that any of the architectures 10, 30 and 50 could also be used to change a database design for change history database 14. In this instance, change history database 14 would act as both a change history database and a production database. Accordingly, change history data would be entered, but not exported. As indicated above, each database in use is generally a copy of a development database. The same reasoning applies to change history database 14. Accordingly, a development database that corresponds to change history database 14 would be used to formulate the design change.

It should also be understood that the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, controls systems 18, 20, 52 and/or 54 such that the carry out the methods described herein. Alternatively, a specific use computer, containing specialized hardware for carrying out one or more of the functional tasks of the invention could be utilized. The present invention can also be embedded in a computer program product, which comprises all the features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

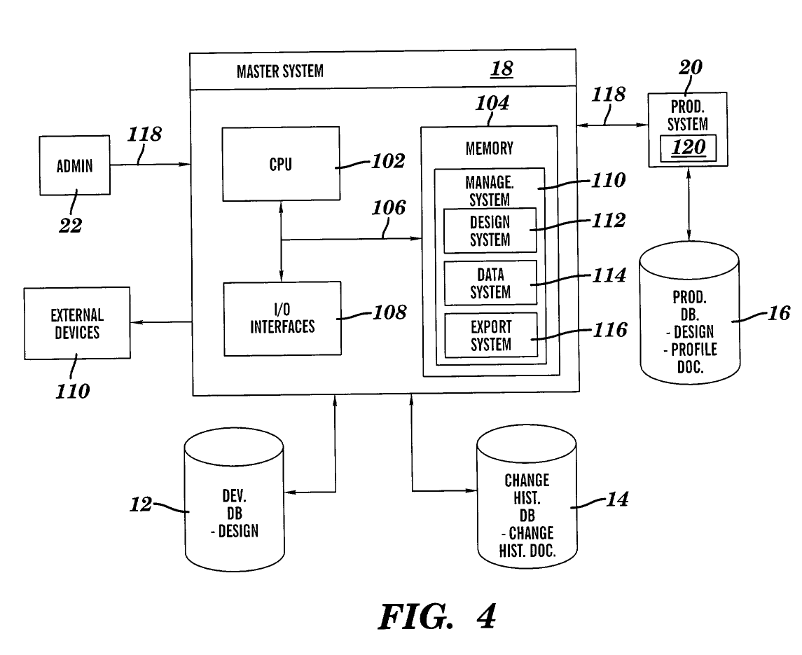

Referring now to FIG. 4, a more detailed view of architecture 10 of FIG. 1 is shown. As depicted, master system 18 resembles a typical computerized system and generally comprises central processing unit (CPU) 102, memory 104, bus 106, input/output (I/O) interfaces 108 and external devices/resources 110. CPU 102 may comprise a single processing unit, or be distributed across one or more processing units in one or more locations, e.g., on a client and server. Memory 104 may comprise any known type of data storage and/or transmission media, including magnetic media, optical media, random access memory (RAM), read-only memory (ROM), a data cache, a data object, etc. Moreover, similar to CPU 102, memory 104 may reside at a single physical location, comprising one or more types of data storage, or be distributed across a plurality of physical systems in various forms.

I/O interfaces 108 may comprise any system for exchanging information to/from an external source. External devices/resources 110 may comprise any known type of external device, including speakers, a CRT, LED screen, hand-held device, keyboard, mouse, voice recognition system, speech output system, printer, monitor, facsimile, pager, etc. Bus 106 provides a communication link between each of the components in master system 18 and likewise may comprise any known type of transmission link, including electrical, optical, wireless, etc. In addition, although not shown, additional components, such as cache memory, communication systems, system software, etc., may be incorporated into master system 18.

As indicated above, development database 12, change history database 14 and production database 16 provide storage for information necessary to carry out the present invention. Accordingly, development database 12 typically has a design that is mirrored on production database 16. Change history database includes a change history document that includes all data regarding changes made to the design of development database 12 and/or production database 16. Similarly, production database 16 includes a profile document that includes all change history data relating to changes made to the design of production database 16.

In a typical embodiment, databases 12, 14 and 16 of the present invention are linked over a network such as a LAN, WAN, VPN or the Internet. Moreover, communication among the systems occurs via communications links 118. Communications links 118 are intended to represent any possible method of communication. For example, communication could occur via a direct hardwired connection (e.g., serial port), or via an addressable connection (e.g., remotely) in a client-server (or server-server) environment. In the case of the latter, the server and client may be connected via the Internet, wide area networks (WAN), local area networks (LAN) or other private networks. The server and client may utilize conventional network connectivity, such as Token Ring, Ethernet, or other conventional communications standards. Where the client communicates with the server via the Internet, connectivity could be provided by conventional TCP/IP sockets-based protocol. In this instance, the client would utilize an Internet service provider to establish connectivity to the server. It should be understood that the components of architectures 30 and 50 of FIGS. 2 and 3 could communicate similarly. For example, development system 52, change history system 54 and production system 20 of FIG. 3 could communicate via a direct or an addressable connection. Furthermore, although not shown, production system 20, development system 52 (FIG. 3) and change history system 54 (FIG. 3) typically include computer components (e.g., CPU 100, etc.) similar to master system 18. Such components have not been shown for brevity purposes.

Stored in memory 104 of master system 18 is management system 110. As shown, management system 110 includes design system 112, data system 114 and export system 116. Design system 112 is available to administrator 22 for using development database 12 to initially develop and/or change a database design. Specifically, as indicated above, administrator 22 will initially create development database 12 to have a specific design (via design system 112). Once created, a production copy (i.e., production database 16) will be made for use by customers or the like. If, at any time, a change to the design is desired, administrator 22 will utilize design system 112 to access development database 12 to formulate the change. Based on the change, change history data will be entered by administrator 22 via data system 114, and stored in a change history document within change history database 14. Once the change history data has been entered, export system 116 will communicate with production system 20 to: (1) implement the change on production database 16; (2) automatically send the change history data to production database 16; and (3) optionally update a version number of production database 16. To this extent, production system 20 could include reception system 120 for accepting the design change, the change history details and the updated version number. Moreover, as indicated above, production database 16 typically includes a profile document that lists its change history. If this is the case, the change history data exported from change history database 14 will be stored in the profile document.

As indicated above, the present invention can be recognized as hardware, software or a combination of hardware and software. To this extent, it should be appreciated that design system 112, data system 114 and export system 116 could include one or more user interfaces for providing the functionality described herein. For example, design system could have a design interface that allows administrator 22 to create/change a particular database design, while data system 114 could have a data entry interface for allowing administrator 22 to enter change history data corresponding to a particular design change. Similarly, export system 116 could have an export interface that allows administrator 22 to select a particular design change, a particular change history document, and a particular production database 16 and/or production system 20 to which the change and the data will be exported.

It should also be appreciated that the systems 112, 114 and 116 of management system 110 could be implemented using “agents.” As known in the art, an agent is a program that performs some function or activity over a network. For example, export system 116 could include an export agent for sending change history data to production database 16, and for updating the version number of production database 16. It should also be understood that the embodiment of management system 110 shown in FIG. 4 is for exemplary purposes only and many variations could exist. For example, export system 116 could be broken down into two distinct systems (not shown): (1) an implementation system for implementing the design change; and (2) a history system for sending the change history data to production database 16 and optionally updating the version number.

It should be further appreciated that when the architectures of FIG. 2 or 3 are implemented, the configuration of management system 110 may change. For example, under architecture 30 shown in FIG. 2, production system 20 is not present. Accordingly, reception system 120 is not necessary. Moreover, under architecture 50 of FIG. 3, development system 52 would likely include design system 112, while change history system 54 would likely include data system 114. Depending on how architecture 50 is implemented, development system 52 and/or change history system 54 could include export system 116.

The present invention is typically implemented using LOTUS products available from International Business Machines, Corp. of Armonk, N.Y. For example change history database 14 could be a LOTUS NOTES database. Moreover, any agents utilized in the present invention could be LOTUSCRIPT agents. However, it should be understood that the use of LOTUS products is only one way to implement the present invention and may alternatives exist.

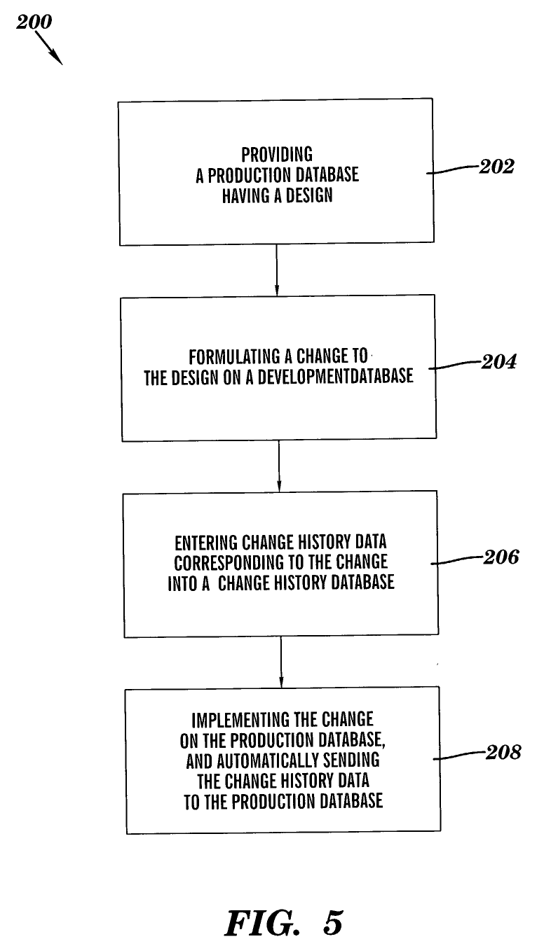

Referring now to FIG. 5, a method flow chart 200 according to the present invention is shown. As depicted, first step 202 of method 200 is to provide a production database having a design. Second step 204 is to formulate a change to the design on a development database. Third step 206 is to enter change history data corresponding to the change into a change history database. Fourth step 208 is to implement the change on the production database, and to automatically send the change history data to the production database.

It should be understood that although a specific order of steps has been cited herein, the present invention could take many variations. For example, the change history data could be entered and transmitted to production database 16 before the change is actually implemented/exported.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A method for maintaining a change history for a database design, comprising:
providing a production database having a design;
formulating a change to the design;
entering change history data corresponding to the change into a change history database;
implementing the change; and
automatically sending the change history data to the production database.

2. The method of claim 1, wherein the production database is a production copy of a development database.

3. The method of claim 2, wherein the formulating step comprises formulating a change to the design, on the development database.

4. The method of claim 1, wherein the entering step comprises entering change history data corresponding to the change into a document on a change history database.

5. The method of claim 1, wherein the production database includes a profile document, and wherein the change history data is copied to the profile document.

6. The method of claim 1, wherein the production database and the change history database communicate over a network.

7. The method of claim 1, further comprising updating a version number of the production database when the change is implemented.

8. A method for maintaining a change history for a database design, comprising:
providing a development database having a design, and a production database, wherein the production database is a production copy of the development database;
making a change to the design on the development database;
entering change history data corresponding to the change into a document on a change history database;
implementing the change on the production database; and
automatically sending the change history data to the production database.

9. The method of claim 8, wherein the development database, the production database, and the change history database communicate over a network.

10. The method of claim 8, wherein the production database includes a profile document.

11. The method of claim 10, wherein the step of automatically sending comprises copying the change history data to the profile document.

12. The method of claim 8, further comprising updating a version number of the production database when the change is implemented.

13. A system for maintaining a change history for a database design, comprising:
a design system for formulating a change to a design of a production database using a development database;
a data system for entering change history data corresponding to the change into a change history database; and
an export system for implementing the change on the production database, and for automatically sending the change history data to the production database.

14. The system of claim 13, wherein the change to the design is made on a development database, and wherein the production database is a production copy of the development database.

15. The system of claim 13, wherein the change history data is entered into a change history document in the change history database.

16. The system of claim 13, wherein the transmission system copies the change history data to a profile document in the production database.

17. The system of claim 13, wherein the transmission system comprises an export agent.

18. The system of claim 17, wherein the export agent updates a version number of the production database when the change is implemented.

19. The system of claim 13, wherein the change history database and the production database communicate over a network.

20. A program product stored on a recordable medium for maintaining a change history for a database design, which when executed, comprises:
program code for formulating a change to a design of a production database using a development database;
program code for entering change history data corresponding to the change into a change history database;
program code for implementing the change on the production database; and
program code for automatically sending the change history data to the production database.

21. The program product of claim 20, wherein the change to the design is made on a development database, and wherein the production database is a production copy of the development database.

22. The program product of claim 20, wherein the change history data is entered into a change history document in the change history database.

23. The program product of claim 20, wherein the program code for automatically sending copies the change history data to a profile document in the production database.

24. The program product of claim 20, wherein the program code for automatically sending comprises an export agent.

25. The program product of claim 24, wherein the export agent updates a version number of the production database when the change is implemented.

26. The program product of claim 20, wherein the change history database and the production database communicate over a network.
